(19) United States
(12) Patent Application Publication
(10) Pub. No.: US 2024/0423413 A1
(43) Pub. Date: Dec. 26, 2024

(54) GRILL SYSTEM

(71) Applicant: Lane McClanahan, Fruitland, IA (US)

(72) Inventor: Lane McClanahan, Fruitland, IA (US)

(21) Appl. No.: 18/749,331

(22) Filed: Jun. 20, 2024

Related U.S. Application Data
(60) Provisional application No. 63/509,191, filed on Jun. 20, 2023.

(51) Int. Cl. A47J 37/07; A47J 33/00

(52) U.S. Cl. CPC A47J 37/0772; A47J 33/00

(57) ABSTRACT

Various aspects of a grill system are discussed herein, including a motor assembly that is configured to rotate a spindle, which is connected to a clutch assembly configured to allow for stopping rotation of a grill without inhibiting the motor assembly. The clutch assembly may be connected to a harness assembly and/or an elevation assembly that connects to the grill. The harness assembly may have a separator that is connected between a suspension line that connects to the clutch assembly and a separator line that connects about a grate that holds a grill. When the motor rotates the spindle, the grate is also rotated about the same vertical axis extending through the spindle. The grill system may also comprise a frame assembly that is configured to elevate the motor about the grate and a source of heat, such as a fire.

### CROSS REFERENCE TO RELATED APPLICATION

This application claims the benefit U.S. Provisional Application Ser. No. 63/509,191 filed Jun. 20, 2023, the contents of this application is hereby incorporated by reference in its entirety.

### FIELD OF THE INVENTION

The various aspects disclosed herein relate a grill system for cooking food. More specifically, the disclosure relates to a motorized grill that provides for automated cooking for both direct and indirect heating through rotation about a vertical axis.

### BACKGROUND OF THE INVENTION

Grills are known in the art. A variety of grills are known in the art, including gas, wood, pellet, and charcoal grills. Conventional grills provide only a static cooking surface that is arranged above a heat source, e.g., fire. While useful, conventional grills can be difficult to use when attempting to cook large food products that will not cook evenly over a constant heat source.

To remediate this, some grills provide a division where one side of the grill is heated and another is not. This is accomplished by having different burners or pits. To make use of such grills, the food product is manually transitioned between the two locations to provide direct and indirect heating. Although advantageous, difficulties remain.

For example, such grill configurations have a large footprint. This causes issues when the grill is intended to be used in various locations and not simply a single, fixed location, such as when camping. Further to this deficiency, the size of a heat source is often limited if using a traditional campfire as it is desirous to limit the diameter of the fire to ensure control is maintained and to also maximize use of the campground afforded. Other problems relate to the general size of most grills that are not readily collapsible for simple transport, including by way of backpacking and the like.

Rotisserie cooking or spit roasting food is a way of cooking a food product that allows for direct and indirect heating during the cooking as the food product rotates about a horizontal axis. Known rotisseries suffer from their other drawbacks. For one, rotisseries must be rotated either manually or in an automated fashion, which requires constant involvement and/or a large footprint to accommodate the means for automated rotation. Additionally, adjustment of the food product is difficult, if not impossible as a rod is inserted through the food product and cannot be adjusted without removal and reinsertion, which also stops the cook during that process.

Thus it is a primary aspect of this disclosure to provide a grill system that improves upon the art.

Another aspect of this disclosure is to provide a grill system that provides for indirect and direct cooking.

Yet another aspect of this disclosure is to provide a grill system that allows for simple adjustment of a food product.

Another aspect of this disclosure is to provide a grill system that has a limited footprint.

Yet another aspect of this disclosure is to provide a grill system that is automated.

Another aspect of this disclosure is to provide a grill system that is collapsible or readily disassembled.

Yet another aspect of this disclosure is to provide a grill system that can be used in remote areas (such as campgrounds or the wilderness).

Another aspect of this disclosure is to provide a grill system that is user friendly.

These and other aspects, features, and advantages of the invention will become apparent from the specification and claims.

### SUMMARY OF THE INVENTION

Discussed herein are various grill systems and methods of using the same.

In Example 1, a grill system comprises a motor assembly that has a spindle, a clutch assembly that has a clutch connector which connects to the spindle, and a harness assembly that has a harness line that connects between the clutch connector and a platform. The motor assembly is configured to rotate the spindle so that when the spindle rotates, the platform also rotates about the same vertical axis that extends through the spindle. The clutch assembly is configured to rotate with the spindle as well, but can be held in a static position with manual intervention without preventing the spindle from continuing to rotate.

Example 2 relates to the grill system according to Example 1, further comprising the motor assembly having a motor with an interface, which allows the speed of the motor to be adjusted as well as to turn the motor off and on.

Example 3 relates to the grill system according to Example 1, further comprising a bracket assembly that connects the housing of the motor assembly to a mount plate of a frame assembly.

Example 4 relates to the grill system according to Example 3, further comprising a lock pin that is received through a pin hole in the bracket assembly and the mount plate to secure the two in place with relation to the frame assembly.

Example 5 relates to the grill system according to Example 4, wherein the lock pin is U-shaped.

Example 6 relates to the grill system according to Example 1, further comprising a frame assembly that has at least one leg which connects to the motor assembly.

Example 7 relates to the grill system according to Example 6, further comprising the spindle received through spindle hole of the frame assembly.

Example 8 relates to the grill system according to Example 6, wherein the frame assembly has three legs; two of which are fixedly connected to a mount plate and the other is connected with a leg connector that is a thumb screw.

Example 9 relates to the grill system according to Example 1, further comprising the spindle having a greaseless bearing assembly.

Example 10 relates to the grill system according to Example 9, further comprising the greaseless bearing assembly having a top washer, an intermediate washer, and a bottom washer. The intermediate washer, which is made of polytetrafluoroethylene, is sandwiched between the top washer and the bottom washer.

Example 11 relates to the grill system according to Example 10, further comprising the greaseless bearing assembly positioned between a housing of the motor assembly and a mount plate of the frame assembly.

Example 12 relates to the grill system according to Example 1, further comprising an elevation assembly that has an elevation line that connects to the clutch connector and the harness assembly.

Example 13 relates to the grill system according to Example 1, further comprising the harness assembly having a suspension line that connects between a separator and the clutch connector. The harness line connects to the separator and the platform.

Example 14 relates to the grill system according to Example 13, further comprising the separator having a hub from which a separator arm extends to an eyelet and the harness line connects to the outline and the platform.

Example 15 relates to the grill system according to Example 1, further comprising the harness assembly having three suspension lines that connect at one end to the clutch connector and about a separator in a triangular arrangement.

Example 16 relates to the grill system according to Example 15, further comprising the harness assembly having three harness lines that connect between the separator and the platform in a triangular arrangement.

Example 17 relates to the grill system according to Example 1, further comprising a grill assembly that is placed on the platform. The platform is positioned to be partially on and off of a heat source so that when rotating only a portion of the platform is ever above the heat source.

Example 18 relates to the grill system according to Example 17, further comprising the grill assembly having a grill housing, a grill lid, and a thermometer.

Example 19 relates to the grill system according to Example 1, wherein the clutch connector is a rotatable lobster clasp and the harness line is a chain.

Example 20 relates to the grill system according to Example 1, wherein the spindle has a portion that has a smaller diameter and a greaseless bearing assembly is received around the portion.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a front view of a grill system according to an aspect of the disclosure;

FIG. 2 is a rear view of a grill system according to an aspect of the disclosure;

FIG. 3 is a top perspective view of a grill system according to an aspect of the disclosure;

FIG. 4 is a side perspective view of a grill system according to an aspect of the disclosure;

FIG. 5 is a top view of a grill system according to an aspect of the disclosure;

FIG. 6 is a front perspective view of a grill system partially disassembled according to an aspect of the disclosure;

FIG. 7 is a bottom perspective view of a grill system according to an aspect of the disclosure;

FIG. 8 is a front perspective view of a grill system according to an aspect of the disclosure;

FIG. 9 is a top perspective view of a grill system according to an aspect of the disclosure;

FIG. 10 is a rear perspective view of a grill system according to an aspect of the disclosure; and

FIG. 11 is a top perspective view of a grill system according to an aspect of the disclosure.

### DETAILED DESCRIPTION

The disclosure described herein is directed to different aspects of a grill system. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details.

The various aspects disclosed and contemplated herein relate to grill systems and related designed to achieve satisfactory benefits over traditional grill systems. The disclosure herein may refer to certain aspects, iterations, embodiments, and examples but it is understood that the disclosure can be embodied in many different forms and should not be construed as limited to the aspects set forth herein. For instance, reference is made to a plurality or a pair of an element, where a singular or more than two of such element is contemplated.

The disclosure described herein is directed to different aspects of a grill system. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”. The disclosure is described herein with reference to certain aspects, iterations, embodiments, and examples but it is understood that the disclosure can be embodied in many different forms and should not be construed as limited to the aspects set forth herein.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the Figures. Contemplation of aspects involving direct connections are further provided in the aspects presented in the Figures.

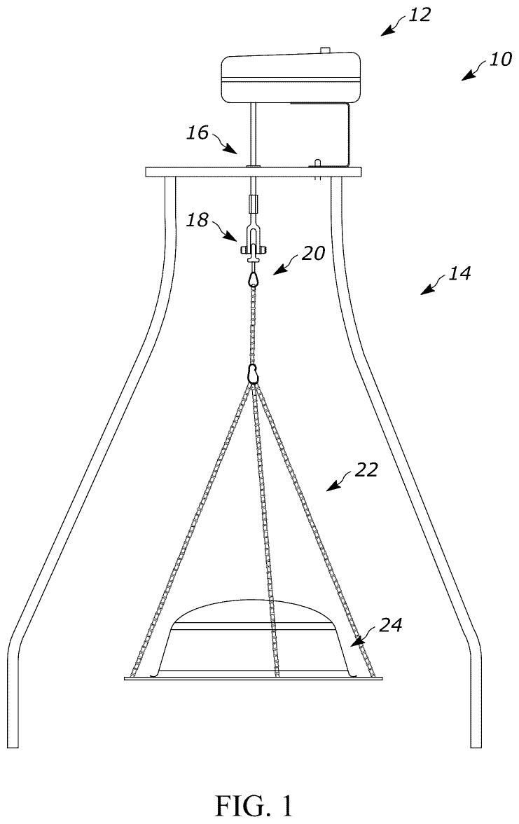

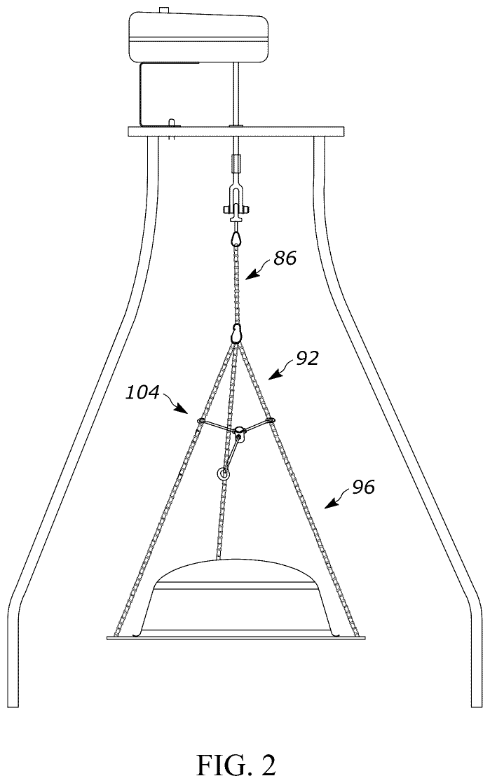

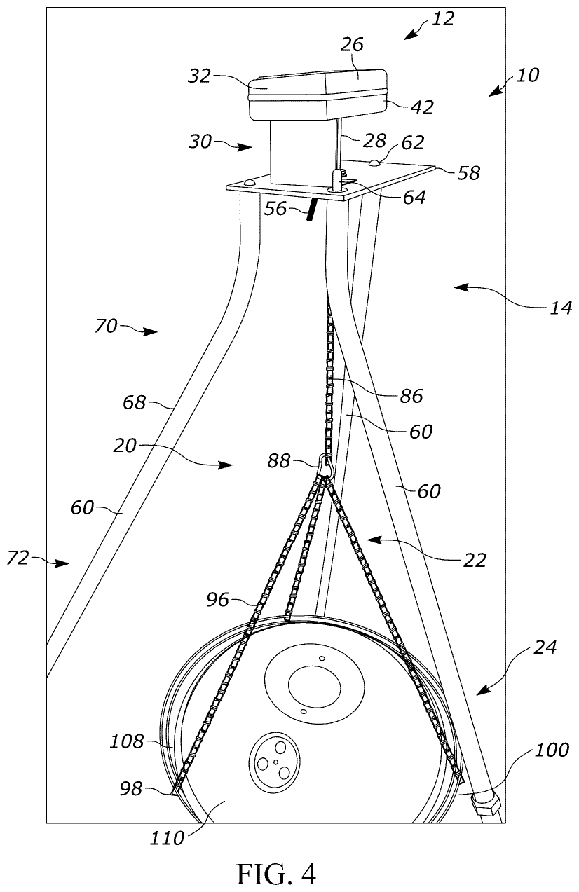

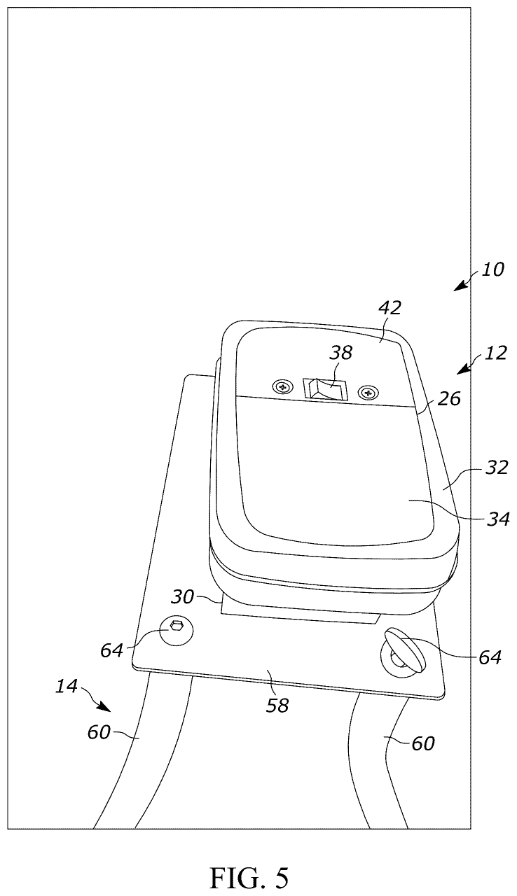

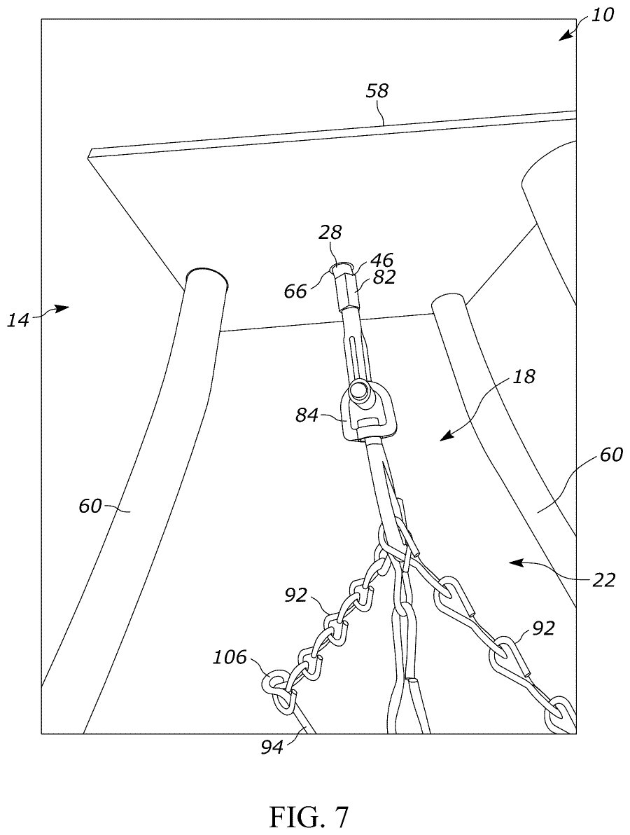

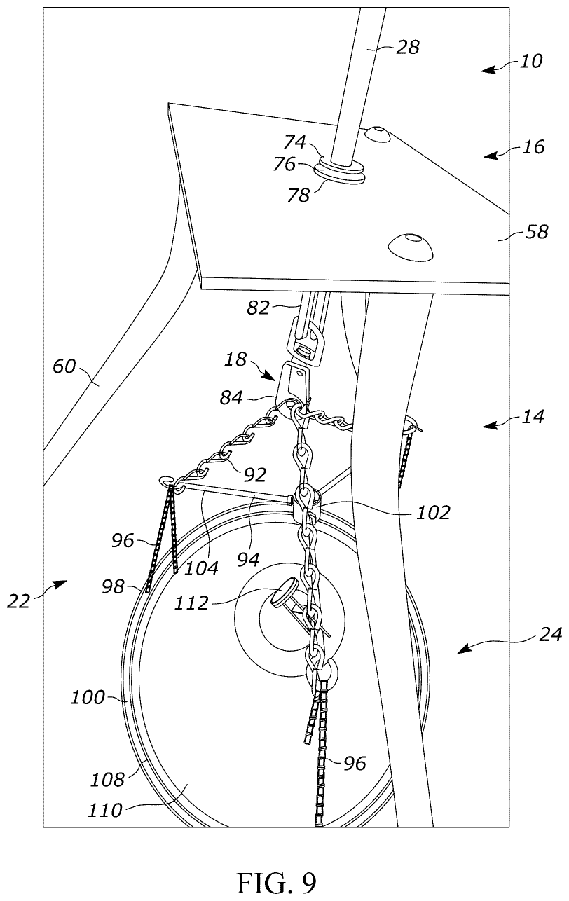

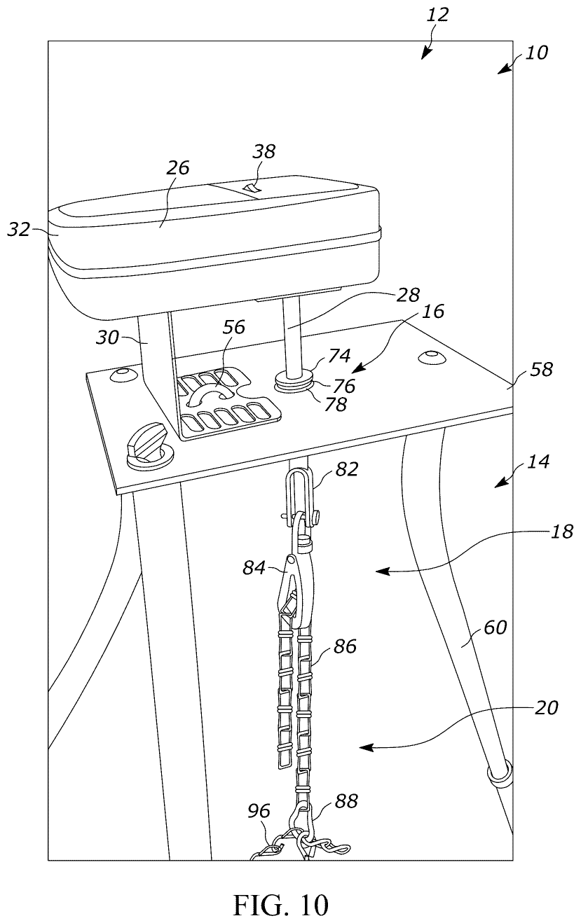

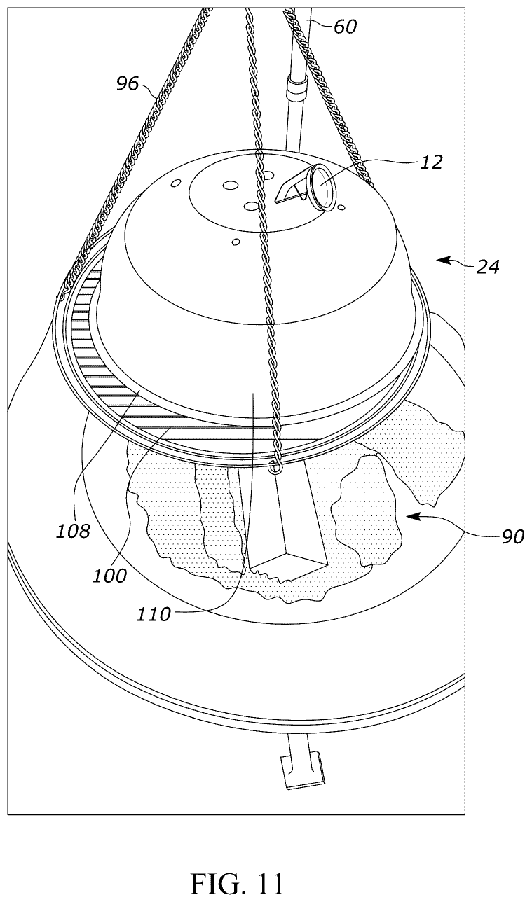

With reference to FIGS. 1-11, aspects that may comprise a grill system 10 are shown. FIGS. 1 and 2 depict the grill system 10 may comprise a motor assembly 12, a frame assembly 14, a greaseless bearing assembly 16, a clutch assembly 18, an elevation assembly 20, harness assembly 22, and/or a grill assembly 24.

FIGS. 1-6, 10, and 11 show that the motor assembly 12 may comprise one or more of a motor 26, a spindle 28, and a bracket assembly 30. The motor 26 may be contained in a housing 32 that has a top 34 and a bottom 36. The housing 32 may have an interface 38 that is configured to operate the motor 26 such as by way of powering the motor 26 off and on and/or setting the speed at which the motor 26. The interface 38 may be positioned on the top 34 of the housing 32. The bottom 36 of the housing 32 may have a bracket connector 40 that is configured to connect, such as by way as slotted receipt, to the bracket assembly 30.

The housing 32 may also connect to a power source 42, such as a wired plug extending from housing 32 or a battery (not shown), such as a rechargeable battery contained within the housing 32 adjacent the motor 26. The power source 42 is configured to provide power to the motor 26 during operation of the motor 26.

The spindle 28 may extend from a proximal end 44 that is operatively connected to the motor 26 vertically such that the spindle 28 may extend from the bottom 36 of the housing 32 towards a distal end 46. The spindle 28 is configured to rotate about a vertical axis extending along a length extending between the proximal end 44 and the distal end 46 of the spindle 28 during operation of the motor 26.

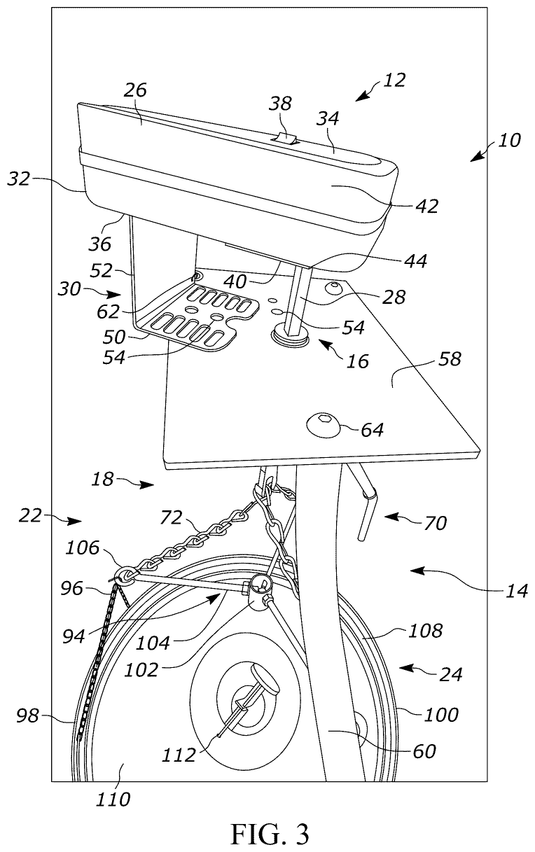

FIGS. 3, 6, and 10 show aspects of the bracket assembly 30 that may have a generally U-shaped that is comprised of an upper plate 48, a lower plate 50, and a connecting plate 52 that extends between the upper plate 48 and the lower plate 50. The upper plate 48 may be sized and shaped to be received or otherwise connect to the housing 32 via the bracket connector 40. The lower plate 50 may be sized and shaped such that when the bracket assembly 30 is connected to the housing 32 the lower plate 50 does not extend to the location of the spindle 28. In this way, the bracket assembly 30 can be easily removed from the housing 32 without concern for the spindle 28.

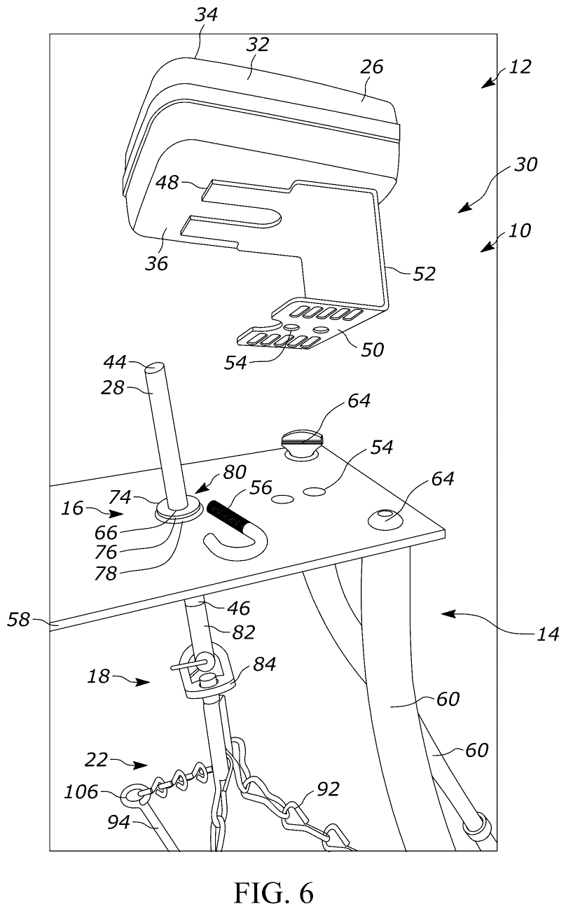

The lower plate 50 may have a pin hole or a plurality of pin holes 54 that selectively receive a lock pin 56 that secures the bracket assembly 30 to the frame assembly 14 described herein. As shown in, at least, FIG. 6, the lock pin 56 may be U-shaped or J-shaped such that the ends of the lock pin 56 are received through the plurality of pin holes 54 such that the motor assembly 12 cannot move laterally or rotationally during operation. In such configurations, the shape of the lock pin 56 provides simplistic method to assemble and disassemble the bracket assembly 30 from the frame assembly 14. Likewise, when the bracket assembly 30 slidably connects to the housing 32, the housing 32 is easily disassembled from the bracket assembly 30.

FIGS. 1-5, 9, and 11 show aspects of the frame assembly 14 that may comprise one or more of a mount plate 58 and one or a plurality of legs 60. The mount plate 58 is configured to connect the motor assembly 12 to the frame assembly 14. The mount plate 58 may comprise the pin hole or the plurality of pin holes 54 such that the lock pin 56 passes through both the lower plate 50 of the housing 32 and the mount plate 58.

The mount plate 58 may comprise one or a plurality of leg holes 62 that receive a leg connector 64 that passes through the mount plate 58 and into one of the plurality of legs 60. In some aspects, one or more of the leg connector 64 may be a thumb screw that simplifies the removal. The remainder of the plurality of legs 60 may be fixedly connected including by way of monolithic construction or welding, such that disassembly from the mount plate 58 is not readily possible. The use of a thumb screw as one of the leg connector 64 retains the benefit of reducing the size of the frame assembly 14 sufficiently for easy transport. In further aspects, all of the leg connector 64 may be thumb screws or all the plurality of legs 60 may be fixedly connected to the mount plate 58. The mount plate 58 may also comprise a spindle hole 66 through which the spindle 28 passes.

In some aspects, the one or the plurality of legs 60 may be bent such that each flares outwardly from the mount plate 58 to a bend 68 and bends downwardly from the bend 68 to a ground surface. In this configuration, the plurality of legs 60 form a neck 70 that bends into a body 72 that is sized and shaped to be positioned around the grill assembly 24 as described herein. Further, this configuration minimizes the vertical footprint of the grill system 10. In other aspects, the plurality of legs 60 are straight or any other shape. In still other aspects, the plurality of legs 60 is a single leg or any number greater than one. As shown in the Figures, the plurality of legs 60 is a tripod with three legs that provides for independent stability without staking and with a minimum number of legs.

FIGS. 3, 6, 9, and 10 show aspects of the greaseless bearing assembly 16 that the spindle 28 is received through. The greaseless bearing assembly 16 may comprise one or more of a first or top washer 74, a second or intermediate washer 76, and a third or bottom washer 78. The intermediate washer 76 may be comprised of polytetrafluoroethylene (PTFE; also known as Teflon®). The greaseless bearing assembly 16 may be abut the mount plate 58 and be positioned between the housing 32 and the mount plate 58. The greaseless bearing assembly 16 may be positioned on a portion 80 of the spindle 28 that has a smaller diameter than the remainder of the spindle 28 such that the greaseless bearing assembly 16 is sandwiched between the spindle 28 and the mount plate 58. The use of PTFE for the intermediate washer 76 facilitates rotation of the spindle 28.

FIGS. 1, 2, and 6-10 show aspects of the clutch assembly 18 that may comprise one or more of a spindle connector 82 and a clutch connector 84. The clutch connector 84 is configured to rotate with the spindle 28 during normal operation of the grill system 10 without manual intervention, but to remain static while the spindle 28 continues to rotate when manually intervened with as described further herein. The spindle connector 82 may be an anchor shackle to allow for simplified disassembly as is described herein. The spindle connector 82 may be fixedly attached to the spindle 28 including by way of welding or screwed attachment. The clutch connector 84 may rotatably connect to the spindle connector 82 as depicted but aspects of the grill system 10 contemplate the clutch connector 84 connecting to the spindle 28. The clutch connector 84 may be a rotatable lobster clasp, which allows for simplified disassembly.

FIGS. 1, 2, 4, 10, and 11 show aspects of the elevation assembly 20 that may comprise one or more of elevation line 86 and an elevation connector 88. The elevation assembly 20 is configured to adjust the height of the grill assembly 24 in relation to a heat source 90, which in turn modifies the heat the grill assembly 24 is exposed to during a cook as described herein. The elevation line 86 may connect between the clutch connector 84 and the elevation connector 88. The elevation line 86 may be a chain that provides the advantage of permitting simplified adjustment of the length of the elevation line 86 between the clutch connector 84 and the elevation connector 88 by changing which link in the chain the clutch connector 84 connects; and/or which connects to the elevation connector 88. In some aspects, the elevation line 86 may connect directly to the grill assembly 24. The elevation connector 88 may be a spring hook or a carabiner to allow for simplified attachment and detachment as modifications are made to the length of the elevation line 86.

FIGS. 1, 2, 3, 8, and 9 show aspects of the harness assembly 22 that may comprise one or more of a suspension line 92, a separator 94, one or more of a harness line 96, a platform connector 98, and a platform 100. The harness assembly 22 is configured to hold the grill assembly 24 while also expanding the area above the grill assembly 24 to ease use of the grill assembly 24 without the hinderance or interference of the one or more of the suspension line 92 as described further herein.

The suspension line 92 may connect between the clutch assembly 18 and the separator 94 or between the clutch assembly 18 and the elevation connector 88. As shown, the grill system 10 may have three of the suspension line 92 but may also have a single of the suspension line 92 as well as any number of the suspension line 92. The use of three of the suspension line 92 provides for the highest stability of the separator 94 with the fewest number of the suspension line 92, which in turn simplifies assembly and disassembly, while maintaining a sturdy construction of the grill system 10. In such a configuration, the three of the suspension line 92 radiate outwardly and downwardly in a triangular or pyramidal arrangement.

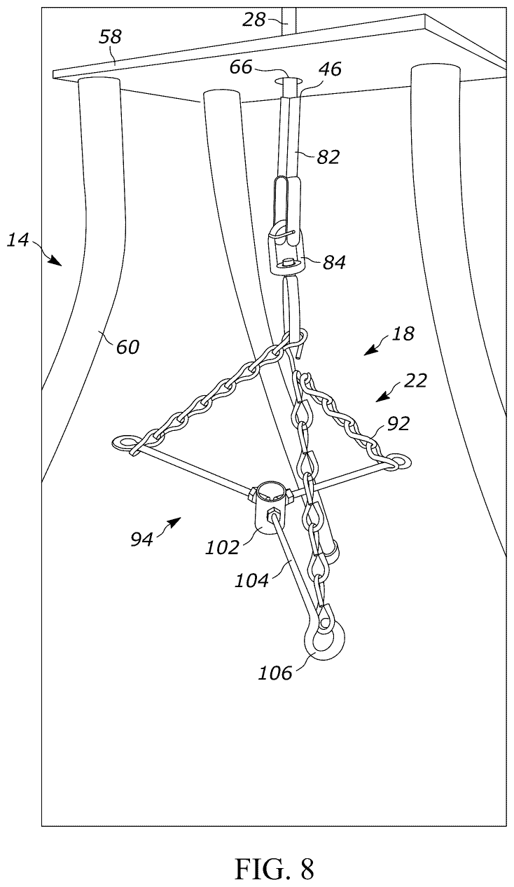

The separator 94 is configured to rigidly separate the one or more of the harness line 96 from one another. The separator 94 may comprise a hub 102 and one or more of a separator arm 104 that may have an eyelet 106 at an opposite end from the connection to the hub 102. The hub 102 may be cylindrical but other shapes are considered. The separator 94 may have three of the separator arm 104 that are equidistantly positioned about the hub 102 such that the ends of the three of the separator arm 104 are arranged in a triangular pattern. The eyelet 106 of each of the separator arm 104 may connect one of the multiple of the suspension line 92 as seen in, at least, FIG. 8. In certain aspects, the separator arm 104 and the eyelet 106 are an elongated eye bolt that screws into the hub 102.

The one or more of the harness line 96 are configured to connect about platform 100 with the platform connector 98. While any number of the harness line 96 is contemplated, the use of three of the harness line 96 provides for the highest stability with the fewest number of the harness line 96, which in turn simplifies assembly and disassembly, while maintaining a sturdy construction of the grill system 10. Each of the harness line 96 may connect between the platform 100 and the separator 94 through connection to the eyelet 106, or the elevation connector 88, or the clutch connector 84. When connected to the elevation connector 88 or the clutch connector 84 and three of the harness line 96 are present, the three of the harness line 96 radiate outwardly and downwardly in a triangular or pyramidal arrangement to the grill assembly 24. The harness line 96 may pass through the eyelet 106 to the elevation connector 88 or the clutch assembly 18 rather than connecting to the eyelet 106. In such a configuration, the suspension line 92 is omitted. The harness line 96 may be a chain to facilitate adjustment of the length of the harness line 96 as discussed previously with relation to the elevation line 86.

The platform connector 98 is configured to connect the harness line 96 to the platform 100. When connected, the harness assembly 22 provides a stability to the platform 100 such that a safe area is available for receipt of the grill assembly 24. The platform connector 98 may be a lobster clasp, a ring clasp, a slide clasp, or other suitable device. The use of such clasps simplifies assembly and disassembly of the grill system 10.

FIGS. 1-4, 9, and 11 show aspects of the grill assembly 24 that may comprise one or more of a grill housing 108, a grill lid 110, and a thermometer 112. The grill assembly 24 is configured to cook a food product, such as meat and/or vegetables over the heat source 90, which can be a wood fire, charcoal fire, or the like. The thermometer 112 may be received through the grill housing 108 or the grill lid 110 to provide the current internal temperature of the grill assembly 24.

In an exemplary assembly, the frame assembly 14 is constructed by positioning the two of the plurality of legs 60 that are fixedly connected to the mount plate 58 into position and then connecting the third of the plurality of legs 60 with the leg connector 64 that is a thumb screw. With the spindle 28 and the clutch assembly 18 already positioned through the mount plate 58, the motor 26 is connected to the bracket assembly 30 and then the spindle 28 is inserted into the motor 26. To retain the position of the motor assembly 12 the lock pin 56 is positioned through the bracket assembly 30 and the mount plate 58 via the plurality of pin holes 54.

The elevation assembly 20 or the harness assembly 22 is connected to the clutch assembly 18. For instance, the elevation line 86 is connected to the clutch connector 84 or the suspension line 92 to the clutch connector 84. When the suspension line 92 is used, the suspension line 92 is also connected to the separator arm 104 of the separator 94. Connection is readily accomplished when the various clasps discussed herein are utilized. Then the harness line 96 is connected at one end to the elevation assembly 20 or the separator 94 and to the platform 100 at the other. The height of the of the platform 100 with relation to the ground surface is accomplished by shortening or lengthening one or more of the elevation line 86, suspension line 92, and/or the harness line 96. The platform 100 may be a grate to expose the grill assembly 24 directly to the heat source 90 during operation.

In operation, the frame assembly 14 is positioned such that the platform 100 is partially positioned over the heat source 90 such that a portion of the platform 100 is above the ground surface and a portion is above the heat source 90. The grill assembly 24 is then placed on the platform 100. Using the interface 38, the motor 26 is turned on and the speed of the motor 26 is defined.

The weight of the clutch assembly 18, elevation assembly 20 and/or harness assembly 22, and the grill assembly 24 pulls on the spindle 28. This pull compresses the greaseless bearing assembly 16, which facilitates rotation of the grill system 10. The weight of the grill system 10 causes the clutch connector 84 to rotate dependently with the spindle 28.

The rotation of the spindle 28 causes the platform 100 to rotate due to the connections described herein. Hence, the motor assembly 12 is configured to rotate the spindle 28 such that the platform 100 rotates with the spindle 28 about a vertical axis extending through spindle 28. As the grill assembly 24 rotates with the platform 100, a portion of the grill assembly 24 is exposed to the heat source 90 whereas the portion of the grill assembly 24 above the ground surface is not. In this way, the food in the grill assembly 24 is slowly cooked through direct and indirect heating. To adjust the food in the grill assembly 24, the elevation assembly 20 or the grill assembly 24 is held such that the clutch connector 84 no longer rotates with the spindle 28 to hold the grill assembly 24 in a static position. To continue rotation, the elevation assembly 20 or the harness assembly 22 is simply released such that the spindle 28 again rotates the platform 100 due to the weight upon the clutch connector 84.

Some of the advantages of certain aspects disclosed herein include the following. The grill system 10 has been provided that provides for indirect and direct cooking; allows for simple adjustment of a food product; has a limited footprint; is automated; is collapsible or readily disassembled; can be used in remote areas (such as campgrounds or the wilderness); is user friendly, and improves upon the art.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

Although the present invention has been described with reference to embodiments, persons skilled in the art will recognize that changes may be made in form and detail without departing from the spirit and scope of the invention. The description is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A grill system comprising:
a motor assembly having a spindle;
a clutch assembly having a clutch connector connected to the spindle; and
a harness assembly having a harness line connected between the clutch connector and a platform;
wherein the motor assembly is configured to rotate the spindle such that the platform rotates with the spindle about a vertical axis extending through the spindle;
wherein the clutch assembly is configured to rotate with the spindle unless held in a static position through manual intervention,
wherein when the clutch assembly is held in the static position the spindle still rotates.

2. The grill system of claim 1 further comprising the motor assembly having a motor and an interface, wherein the interface is configured to selectively power the motor and set a speed of the motor.

3. The grill system of claim 1 further comprising a bracket assembly and a frame assembly, wherein the bracket assembly connects to a housing containing a motor and to a mount plate of the frame assembly.

4. The grill system of claim 3 further comprising a lock pin received through at least one pin hole of the bracket assembly and the mount plate to secure the bracket assembly in place with relation to the frame assembly.

5. The grill system of claim 4 wherein the lock pin is U-shaped.

6. The grill system of claim 1 further comprising a frame assembly having at least one leg connected to the motor assembly.

7. The grill system of claim 6 further comprising the spindle received through a spindle hole of the frame assembly.

8. The grill system of claim 6 wherein the at least one leg is at least three legs, and wherein two of the at least three legs are fixedly connected to a mount plate and the other of the at least three legs is connected to the mount plate by a leg connector that is a thumb screw.

9. The grill system of claim 1 further comprising the spindle having a greaseless bearing assembly.

10. The grill system of claim 9 further comprising the greaseless bearing assembly having a top washer, an intermediate washer, and a bottom washer, wherein the intermediate washer is made of polytetrafluoroethylene and is positioned between the top washer and the bottom washer.

11. The grill system of claim 10 further comprising the greaseless bearing assembly positioned between a housing of the motor assembly and a mount plate of a frame assembly.

12. The grill system of claim 1 further comprising an elevation assembly having an elevation line connected between the clutch connector and the harness assembly.

13. The grill system of claim 1 further comprising the harness assembly having a first suspension line connected between the clutch connector and a separator, and the harness line connected between the separator and the platform.

14. The grill system of claim 13 further comprising the separator having a hub from which at least one separator arm extends to an eyelet, and the harness line connected to the eyelet at one end and to the platform at the other.

15. The grill system of claim 1 further comprising the harness assembly having three suspension lines connect to the clutch connector at one end and about a separator in a triangular arrangement.

16. The grill system of claim 15 further comprising the harness assembly having three of the harness line that connect to the separator at one end in a triangular arrangement and at the other end to the platform in a triangular arrangement.

17. The grill system of claim 1 further comprising a grill assembly placed on the platform, and the platform partially positioned over top of a heat source and partially not over top of the heat source such that while rotating only a portion of the platform is over the heat source at a given time.

18. The grill system of claim 17 further comprising the grill assembly having a grill housing, a grill lid, and a thermometer.

19. The grill system of claim 1 wherein the clutch connector is a rotatable lobster clasp and the harness line is a chain.

20. The grill system of claim 1 wherein the spindle has a portion that has a smaller diameter and a greaseless bearing assembly is received around the portion.
